(19) United States
(12) Patent Application Publication
(10) Pub. No.: US 2017/0207738 A1
(43) Pub. Date: Jul. 20, 2017

(54) ELECTRIC MACHINE FOR THE POWER SUPPLY OF A MOTOR VEHICLE ELECTRICAL SYSTEM

(71) Applicant: Robert Bosch GmbH, Stuttgart (DE)

(72) Inventors: Reinhard Meyer, Bietigheim-Bissingen (DE); Roberto Carlos Retana Hernandez, Stuttgart (DE)

(21) Appl. No.: 15/328,301

(22) PCT Filed: Jul. 14, 2015
(86) PCT No.: PCT/EP2015/066020

§ 371 Date: Jan. 23, 2017

(30) Foreign Application Priority Data
Jul. 25, 2014 (DE) 102014214717.4
Oct. 30, 2014 (DE) 102014222163.3

(51) Int. Cl. H02P 9/48; F02N 11/08; H02M 3/335; H02P 25/22

(52) U.S. Cl. CPC H02P 9/48; H02P 25/22; F02N 11/0814; H02M 3/33584

(57) ABSTRACT

A method for operating an electric machine including a first group of stator windings and a second group of stator windings, in a first circuit configuration, in-phase stator windings of the first and the second group of stator windings being connected in series between a first pair of subnetwork terminal poles, in a second circuit configuration, the in-phase stator windings of the first and the second group of stator windings being connected in parallel between a second pair of subnetwork terminal poles, and in a third circuit configuration, the stator windings of the first group of stator windings being connected between the first pair of subnetwork terminal poles and the stator windings of the second group of stator windings being connected between the second pair of subnetwork terminal poles, and a correspondingly configured electric machine.

### FIELD

The present invention relates to an electric machine for the power supply of a motor vehicle electrical system having two subnetworks, a corresponding motor vehicle electrical system, and a method for operating an electric machine.

### BACKGROUND INFORMATION

Motor vehicle electrical systems may be designed in the form of so-called two-voltage or multi-voltage vehicle electrical systems having at least two subnetworks. Such subnetworks are used, for example, when consumers having different power requirements are present in a relevant motor vehicle. In this case, at least two of the subnetworks have different voltage levels, for example, 12 V (so-called low-voltage subnetwork) and 48 V (so-called high-voltage subnetwork). Electric machines such as generators may be used for a power supply of the subnetworks. Such an electric machine generates a three-phase current, which may be rectified with the aid of a rectifier circuit for the subnetworks.

One possibility for the power supply of an electrical system of a motor vehicle is described in German Patent No. DE 28 10 201 C2. In the course of a heating operation, electrical consumers having a large power consumption, for example, electrical heaters, are to be supplied with power. As described in German Patent No. DE 28 10 201 C2, such consumers are not connected directly to the vehicle electrical system because of the high power consumption. A three-phase generator has two stator windings. A main stator winding and an auxiliary stator winding each have separate rectifier sets. To supply the corresponding consumers with power in the course of the heating operation, the voltages of the two stator windings are added together after rectification, i.e., on the DC voltage side. For this purpose, the positive and negative diode terminals of the two stator windings are connected in series with the aid of a switching device in a series circuit position and connected to the corresponding consumer. After turning off this heating operation, the voltages of the two stator windings are connected in parallel after rectification.

Such a power supply is not suitable for modern two-voltage or multi-voltage vehicle electrical systems. It cannot be ensured by such a power supply that both a low-voltage subnetwork and a high-voltage subnetwork are permanently supplied with the particular voltage.

It is therefore desirable to provide a possibility for effectively supplying subnetworks of a motor vehicle electrical system with power.

### SUMMARY

According to the present invention, an electric machine for the power supply of a motor vehicle electrical system having two subnetworks, a corresponding motor vehicle electrical system, and a method for operating an electric machine are provided. Advantageous embodiments are the present invention are described herein.

An electric machine according to the present invention has a first group of stator windings and a second group of stator windings. The electric machine may be regularly operated using each of these groups of stator windings alone. Therefore, two separate, independent stator winding groups are situated on the stator of the electric machine. A stator winding of the first group and a stator winding of the second group, which correspond with respect to the magnetic field permeation or the electric phase (in particular because they are wound in the same stator groove, for example), are referred to hereafter as in-phase stator windings.

The electric machine may be designed as an m-phase or m-strand electric machine having 2×m stator windings (phases).

Advantageous values for this phase number m are, for example, 3, 5, 6, 7, or 9. Voltages of two adjacent stator windings of one group are each shifted by a phase shift of 360°/m.

The electric machine may be designed in particular as a generator. The electric machine may furthermore be designed in particular in such a way that it may be operated in a generator operating mode as a generator and in a motor operating mode as a motor. If the electric machine is operated as a generator, the electric machine generates electrical energy for the power supply of the motor vehicle electrical system.

The electric machine may be connected to a first subnetwork of the motor vehicle electrical system via a first pair of subnetwork terminal poles. The electric machine may be connected to a second subnetwork of the motor vehicle electrical system via a second pair of subnetwork terminal poles. These two subnetworks have different voltage levels in particular.

The first subnetwork is assumed hereafter to be a high-voltage subnetwork by way of example, which is operated using a first subnetwork DC voltage (for example, 48 V), and the second subnetwork is assumed to be a low-voltage subnetwork, which is operated at a second subnetwork DC voltage (for example, 12 V), the first subnetwork DC voltage having a greater voltage value than the second subnetwork DC voltage.

The first group of stator windings is associated with a first rectifier circuit and the second group of stator windings is associated with a second rectifier circuit. A multiphase AC voltage, which is generated in the particular group of stator windings, may be rectified into a DC voltage with the aid of the particular rectifier circuits. The rectifier circuits in particular each have half-bridges including switches, in particular MOSFETs.

According to the present invention, a connection circuit having individual switching elements is situated between in-phase stator windings of the first and the second group of stator windings. In particular, a switching element of the connection circuit is situated in each case between in-phase stator windings of the first and the second group of stator windings. Therefore, in particular m of these switching elements are thus provided. The switching elements of the connection circuit are designed in particular in such a way that they may conduct the current in both directions when switching through. These switching elements may be designed, for example, as bidirectional thyristors (TRIAC) or as inversely parallel MOSFETs.

In particular, the switching elements of the connection circuit are each situated in such a way that in each case the in-phase stator windings of the two groups of stator windings are connected in series upon switching through of the switching elements of the connection circuit. Therefore, a high voltage is already generated in particular at low speeds in the generator operating mode.

According to the present invention, the connection circuit and the rectifier circuits may be operated in different circuit configurations. Therefore, different operating modes result in which the electric machine may be operated. In particular, the connection circuit and the rectifier circuits are driven by an advantageous computer unit, for example, a control unit, to provide the different circuit configurations.

In a first circuit configuration, the in-phase stator windings of the first and the second group of stator windings are connected in series between the first pair of subnetwork terminal poles. All in-phase stator windings are therefore connected in series in pairs. In this first circuit configuration, the first subnetwork of the motor vehicle electrical system is supplied with power.

In a second circuit configuration, the in-phase stator windings of the first group and the second group of stator windings are connected in parallel between the second pair of subnetwork terminal poles. In this second circuit configuration, the second subnetwork of the motor vehicle electrical system is supplied with power.

In a third circuit configuration, the stator windings of the first group of stator windings are connected between the first pair of subnetwork terminal poles, whereby the first subnetwork is supplied with power. At the same time, the stator windings of the second group of stator windings are connected between the second pair of subnetwork terminal poles, whereby the second subnetwork is supplied with power. The in-phase stator windings of the first group and the second group of stator windings are not electrically connected to one another directly in this third circuit configuration.

### SUMMARY

The stator windings of the first group and the second group are combined by the series connection of the in-phase stator windings in the first circuit configuration. Therefore, a combined stator winding made up of the particular in-phase stator windings results for each electrical phase. A number of turns of the windings of the individual electrical phases is increased. This increased number of turns results as the total of the numbers of turns of the particular in-phase stator windings. A voltage which is generated in the electric machine operated as a generator is increased by this series connection of the in-phase stator windings. Therefore, the power provided for the power supply of the motor vehicle electrical system may be increased in particular at lower generator speed.

The in-phase stator windings connected in series are connected to the first subnetwork in the first circuit configuration. In particular, the first and the second rectifier circuits are controlled in the course thereof in such a way that a rectification of the m-phase AC voltage generated in the combined in-phase stator windings is carried out. The power generated by the electric machine is accordingly fed into the first subnetwork.

This first circuit configuration lends itself in particular for the high-voltage subnetwork. It is ensured by the increased voltage or the increased power which may be provided by the electric machine in this circuit configuration that the high-voltage subnetwork is supplied with the comparatively high first subnetwork DC voltage.

In contrast to German Patent No. DE 28 110 201 C2, which was mentioned above, the present invention enables the in-phase stator windings to be connected directly in series. German Patent No. DE 28 110 201 C2 solely enables stator windings to be added after the rectification, i.e., on the DC voltage side. According to German Patent No. DE 28 110 201 C2, the electric machine having two stator windings may be considered as two DC voltage sources, i.e., as two independent electric machines, which provide two DC voltages independently of one another. These provided DC voltages may finally be added together.

In contrast thereto, a much higher level of flexibility results by way of the present invention. On the one hand, the voltage generation in the first circuit configuration by combined in-phase stator windings which are connected in series is much more effective than in German Patent No. DE 28 110 201 C2.

Furthermore, all switches of the rectifier circuits do not have to be activated in the first circuit configuration, while in contrast all switches of both rectifier sets have to be activated in German Patent No. DE 28 10 201 C2.

Furthermore, the present invention also enables the two groups of stator windings to be connected to the individual subnetworks individually and independently of one another. In the context of the third circuit configuration, the stator windings of the first group may be connected to the first subnetwork and may supply it with power. At the same time, the stator windings of the second group may be connected to the second subnetwork and supply it with power independently thereof. It is therefore ensured that both subnetworks are permanently supplied with the particular voltage. The first or the second rectifier circuit is operated in the context thereof in particular in such a way that a rectification of the m-phase AC voltage generated in the first or second group of stator windings is carried out.

In addition, the in-phase stator windings in the second circuit configuration may also be connected in parallel to the second subnetwork. The first or the second rectifier circuit is also operated in this circuit configuration in particular in such a way that a rectification of the m-phase AC voltage generated in the first or second group of stator windings is carried out.

In the second circuit configuration, the second subnetwork may be supplied with a comparatively high current. For example, a battery in the second subnetwork may be charged rapidly in this second circuit configuration.

The electric machine is preferably operated in the second circuit configuration when the electric machine or the vehicle electrical system is operated in a recuperation mode. In the context of such a recuperation mode, for example, energy is recovered during braking phases and an energy store, for example, a battery, is charged. Such a recuperation mode may be used, for example, within the scope of a boost recuperation system (BRS) in the electric machine (boost recuperation machine).

The electric machine is advantageously operated in the first circuit configuration when a drive of the electric machine is operated in an idle state. A drive of the electric machine is to be understood hereafter as a drive which generates mechanical energy or kinetic energy. In particular, the electric machine operated as a generator converts this mechanical or kinetic energy into electrical energy. Such a drive is designed in particular as a drive of the motor vehicle, for example, as an internal combustion engine. Idle state is to be understood in particular to mean that the drive is operated at a comparatively low speed, for example, at speeds of less than 1000 RPM, in particular at speeds between 600 RPM and 1000 RPM. When the electric machine is operated in an idle state of the drive in the third circuit configuration, sufficient power supply of the high-voltage subnetwork may possibly not be ensured, for example, because the number of turns of the individual in-phase stator windings is excessively small. Due to the combination of the in-phase stator windings in the first circuit configuration, sufficient power supply of the high-voltage subnetwork may be ensured, also in the idle state of the drive.

The electric machine is preferably operated in the third circuit configuration when the drive of the electric machine is operated in a work operating mode. If the drive is operated in the work operating mode, i.e., not in the idle state, a sufficient power supply of the subnetworks may also be ensured by the individual groups of stator windings. In such a regular operating mode, the electric machine is operated in particular at comparatively normal or high speeds, in particular at speeds greater than 1000 RPM.

In particular when the rotor of the electric machine described here does not rotate, the connection circuit and the rectifier circuits may advantageously be operated in a further fourth circuit configuration in such a way that the in-phase stator windings of the first and the second group of stator windings are connected as a DC voltage converter for DC voltage conversion between the first and the second pair of subnetwork terminal poles. In the context of this fourth circuit configuration, a DC voltage conversion is carried out between the two subnetworks of the motor vehicle electrical system. As needed, the first subnetwork DC voltage of the high-voltage subnetwork is stepped down and transmitted into the low-voltage subnetwork or the second subnetwork DC voltage of the low-voltage subnetwork is stepped up and transmitted into the high-voltage subnetwork.

The first and the second group of stator windings preferably function as a transformer between the two subnetworks. One of the two rectifier circuits is operated as an inverter as needed, to convert the subnetwork DC voltage of the corresponding subnetwork into an AC voltage. This AC voltage generates a current flow in the associated one of the two groups of stator windings, which in turn induces an AC voltage in the other of the two groups of stator windings. The other of the two rectifier circuits is operated as a rectifier, to rectify this induced AC voltage and feed it into the other subnetwork. In particular, the in-phase stator windings of the first and the second group of stator windings are not electrically connected to one another in this case.

Furthermore, the two stator winding groups and the two rectifier circuits may also preferably be operated as a step-up converter or step-down converter for DC voltage conversion. The in-phase stator windings of the first and the second group of stator windings are electrically connected to one another via the connection circuit in this case.

The already provided parts and components of the rectifier circuits are used accordingly in the course of the DC voltage conversion for the rectification, the inversion, the step-up conversion, the step-down conversion, and/or the transformation, whereby finally the DC voltage conversion is enabled. Therefore, no additional components and parts are required and the cost expenditure may be reduced.

The electric machine is preferably operated in the fourth circuit configuration when the drive of the electric machine is operated in a start-stop operating mode. In the context of such a start-stop operating mode, the drive of the motor vehicle is automatically shut down, for example, in standing phases (for example, at red traffic lights). In such phases with a shut-down drive, the subnetworks are supplied from corresponding energy stores (for example, batteries). During longer standing phases, it may occur that a charge state of the energy store decreases so strongly that recharging of the energy store is required. This may be the case in particular in the low-voltage subnetwork. In conventional motor vehicles, the drive is restarted for this purpose to charge the corresponding energy store using the electric machine and to supply the corresponding subnetwork with power. In such a case, power may be transferred between the subnetworks by the fourth circuit configuration and it is not necessary to start the drive. Therefore, power may be transferred in particular from the high-voltage subnetwork into the low-voltage subnetwork. The low-voltage subnetwork may be supplied from the energy store of the high-voltage subnetwork.

A computer unit according to the present invention, for example, a control unit of a motor vehicle, is configured, in particular by programming, to carry out a method according to the present invention.

The implementation of the method in the form of software is also advantageous, since this causes particularly low costs, in particular if an executing control unit is also used for other tasks and is therefore present in any case. Suitable data carriers for providing the computer program are in particular diskettes, hard drives, flash memories, EEPROMs, CD-ROMs, DVDs, etc. A download of a program via computer networks (Internet, intranet, etc.) is also possible.

Further advantages and embodiments of the present invention are described herein with reference to the figure.

It is understood that the above-mentioned features and the features to be explained hereafter are usable not only in the particular specified combination, but rather also in other combinations or alone, without departing from the scope of the present invention.

The present invention is schematically depicted on the basis of exemplary embodiments in the figure and is described in greater detail hereafter with reference to the figure.

### BRIEF DESCRIPTION OF THE DRAWING

FIG. 1 schematically shows one preferred embodiment of an electric machine according to the present invention.

### DETAILED DESCRIPTION OF EXAMPLE EMBODIMENTS

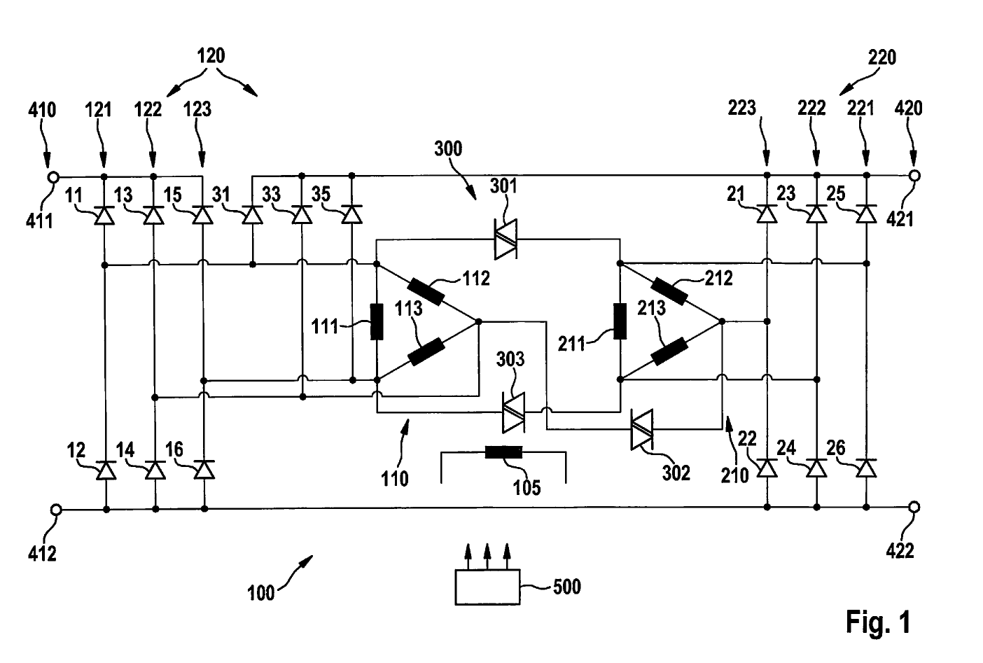

In FIG. 1, a preferred embodiment of an electric machine according to the present invention is schematically shown and identified with reference numeral 100.

Electric machine 100 is designed in this example as a 2×three-phase electric machine. Electric machine 100 has a first group of stator windings 110 and a second group of stator windings 210. Each of groups of stator windings 110 and 210 has three stator windings or phases 111, 112, 113 or 211, 212, 213, respectively. The stator windings of groups of stator windings 110 and 210 are each connected in this example to form a delta circuit. Electric machine 100 furthermore has an exciter winding 105.

One stator winding of first group 110 and one stator winding of second group 210 are provided in each case for each electrical phase of electric machine 100. These stator windings of first group 110 and of second group 210, which are associated with the same electrical phase, are referred to as in-phase stator windings. Therefore, three pairs of in-phase stator windings result for three-phase electric machine 100. In this example, stator windings 111 and 211, 112 and 212, and 113 and 213 are each formed as pairs of in-phase stator windings.

First group of stator windings 110 and second group of stator windings 210 are each associated with a first rectifier circuit 120 and a second rectifier circuit 220, respectively.

Electric machine 100 has a first pair 410 of subnetwork terminal poles 411 and 412. Electric machine 100 may be connected to a first subnetwork of a motor vehicle electrical system via these subnetwork terminal poles 411 and 412. Furthermore, electric machine 100 has a second pair 420 of subnetwork terminal poles 421 and 422. Electric machine 100 may be connected to a second subnetwork of the motor vehicle electrical system via these subnetwork terminal poles 421 and 422.

In this example, the first subnetwork is designed as a high-voltage subnetwork and the second subnetwork as a low-voltage subnetwork. A first subnetwork DC voltage of, for example, 48 V is applied between first pair 410 of subnetwork terminal poles 411 and 412. A second subnetwork DC voltage of, for example, 12 V is applied between second pair 420 of subnetwork terminal poles 421 and 422.

Each of rectifier circuits 120 and 220 includes three half-bridges 121, 122, 123 or 221, 222, 223. Each of the half bridges includes two switches 11 through 16 and 21 through 26, respectively. First rectifier circuit 120 also has, in addition to second rectifier circuit 220, three further switches 31, 33, and 35. Switches 11 through 16, 21 through 26, and 31 through 35 are shown in this example as diodes, but are designed as controllable or switchable switching elements, for example, as MOSFETs.

Each of half-bridges 121, 122, 123 of first rectifier circuit 120 is connected via a center tap to one phase terminal in each case of first group of stator windings 110. This applies similarly to center taps of second rectifier circuit 220 and phase terminals of second group of stator windings 210.

A connection circuit 300 is situated between the stator windings of first group 110 and second group 210. This connection circuit 300 includes three switching elements 301, 302, and 303.

Specifically, switching element 301 is situated between in-phase stator windings 111 and 211, switching element 302 is situated between in-phase stator windings 112 and 212, and switching element 303 is situated between in-phase stator windings 113 and 213. Switching elements 301, 302, 303 are shown in this example as diodes, but are designed as controllable or switchable switching elements which may conduct the current in both directions, for example, as bidirectional thyristors (TRIAC) or as inversely parallel MOSFETs.

Adjacent to electric machine 100, a computer unit is shown, which is designed in particular as a control unit 500 of a motor vehicle. Control unit 500 is configured to activate electric machine 100 and furthermore to operate the motor vehicle electrical system including the two subnetworks. In the context thereof, control unit 500 advantageously activates connection circuit 300 and rectifier circuits 120 and 220. For this purpose, control unit 500 is configured in particular by programming for carrying out one preferred specific embodiment of a method according to the present invention.

The activation of connection circuit 300 and rectifier circuits 120 and 220 is specifically described hereafter by way of example on the basis of the pair of in-phase stator windings 111 and 211. The following statements apply generally in a similar manner to the remaining in-phase stator windings.

In a first circuit configuration, control unit 500 activates connection circuit 300 and rectifier circuits 120 and 220 in such a way that the in-phase stator windings of first group 110 and of second group 210 are connected in series via the particular switching element (301 here) between first pair 410 of subnetwork terminal poles 411 and 412.

For this purpose, control unit 500 activates switches 24, 23, 301, 11, and 12. By activating switch 301, in-phase stator windings 111 and 211 are connected in series. The two stator windings 111 and 211 are therefore combined to form a common stator winding. Combined stator windings 111 and 211 are therefore connected in series in the first subnetwork.

Switches 24, 23, 11, and 12 are chronologically activated in such a way that a rectification of the three-phase AC voltage is carried out, which is generated in the combined stator winding. The first subnetwork is supplied with power in the context of this first circuit configuration.

In a second circuit configuration, control unit 500 activates connection circuit 300 and rectifier circuits 120 and 220 in such a way that the in-phase stator windings of first group 110 and of second group 210 are connected in parallel between second pair 420 of subnetwork terminal poles 421 and 422.

For this purpose, control unit 500 activates switches 23, 24, 25, 26, 12, 31, 16, and 35. The two stator windings 111 and 211 are therefore connected in parallel in the second subnetwork. Switches 23 through 26 are chronologically activated in such a way that a rectification of the three-phase AC voltage which is generated in stator winding 211 is carried out. Switches 12, 31, 16, and 35 are chronologically activated in such a way that a rectification of the three-phase AC voltage which is generated in stator winding 111 is carried out. The second subnetwork is supplied with power in the context of this second circuit configuration.

In a third circuit configuration, control unit 500 activates connection circuit 300 and rectifier circuits 120 and 220 in such a way that the stator windings of first group 110 are connected between first pair 410 of subnetwork terminal poles 411 and 412, and at the same time the stator windings of second group 210 are connected between second pair 420 of subnetwork terminal poles 421 and 422. Switching elements 301, 302, 303 are not conductive, i.e., the stator windings of first group 110 and the stator windings of second group 210 are not directly electrically connected.

For this purpose, control unit 500 activates switches 23, 24, 25, 26, 11, 12, 15, and 16. Stator winding 111 is connected in the first subnetwork and stator winding 211 is connected in the second subnetwork. Switches 23 through 26 are chronologically activated in such a way that a rectification of the three-phase AC voltage which is generated in stator winding 211 is carried out. Switches 11, 12, 15, and 16 are chronologically activates in such a way that a rectification of the three-phase AC voltage which is generated in stator winding 111 is carried out. In the context of this third circuit configuration, the first and the second subnetworks are simultaneously supplied with power.

Furthermore, control unit 500 may activate connection circuit 300 and rectifier circuits 120 and 220 in a fourth circuit configuration in such a way that the in-phase stator windings of first group 110 and of second group 210 are connected as a DC voltage converter, for example, as a transformer for DC voltage conversion here. In the context of this fourth circuit configuration, a DC voltage conversion is carried out between the two subnetworks.

The transmission of electrical power from the first subnetwork into the second subnetwork is described hereafter by way of example. This applies similarly to the transmission of electrical power in the other direction. The first subnetwork DC voltage of 48 V is converted with the aid of first rectifier circuit 120, which is operated as an inverter, into a three-phase AC voltage. Control unit 500 advantageously activates switches 11 through 16 of first rectifier circuit 120 for this purpose. This three-phase AC voltage generates a current flow in first group 110 of stator windings, which in turn induces a three-phase AC voltage in second group 210 of stator windings.

This induced three-phase AC voltage is rectified with the aid of second rectifier circuit 220, which is operated as a rectifier, and fed into the second subnetwork. Control unit 500 advantageously activates switches 21 through 26 of second rectifier circuit 220 for this purpose. The second subnetwork DC voltage may be advantageously set by a clocked activation of the individual switches of first and second rectifier circuits 120 and 220.

An exciting current of exciter winding 105 of electric machine 100 is advantageously equal to zero, so that no synchronous generated voltage is induced in first group 110 of stator windings and second group 210 of stator windings. The transmission of electrical power from one vehicle electrical subnetwork into the other is preferably carried out with deactivated electric machine 100.

1-15. (canceled)

16. An electric machine for the power supply of a motor vehicle electrical system having two subnetworks, the electric machine comprising:
a first group of stator windings, a second group of stator windings, a first pair of subnetwork terminal poles and a second pair of subnetwork terminal poles, wherein the first group of stator windings is associated with a first rectifier circuit and the second group of stator windings is associated with a second rectifier circuit; and
a connection circuit situated between in-phase stator windings of the first and the second group of stator windings;
wherein the connection circuit and the first and second rectifier circuits are switchable into a first circuit configuration, in which the in-phase stator windings of the first and the second group of stator windings are connected in series between the first pair of subnetwork terminal poles via the connection circuit;
wherein the connection circuit and the first and second rectifier circuits are switchable into a second circuit configuration, in which the in-phase stator windings of the first and the second group of stator windings are connected in parallel between the second pair of subnetwork terminal poles; and
wherein the connection circuit and the first and second rectifier circuits are switchable into a third circuit configuration, in which the stator windings of the first group of stator windings are connected between the first pair of subnetwork terminal poles and in which the stator windings of the second group of stator windings are connected between the second pair of subnetwork terminal poles.

17. The electric machine as recited in claim 16, wherein the connection circuit and the first and second rectifier circuits are switchable into a fourth circuit configuration, in which the in-phase stator windings of the first and the second group of stator windings are connected as a DC voltage converter for DC voltage conversion between the first and the second pair of subnetwork terminal poles.

18. The electric machine as recited in claim 17, wherein the connection circuit and the rectifier circuits are switchable into the fourth circuit configuration in such a way that the in-phase stator windings of the first and the second group of stator windings are connected as one of a transformer, as a step-up converter, or as a step-down converter for the DC voltage conversion between the first and the second pair of subnetwork terminal poles.

19. A method for operating an electric machine including a first group of stator windings and a second group of stator windings, the method comprising:
connecting, in a first circuit configuration, in-phase stator windings of the first and the second group of stator windings, in series between a first pair of subnetwork terminal poles;
connecting, in a second circuit configuration, the in-phase stator of the first and the second group of stator windings, in parallel between a second pair of subnetwork terminal poles; and
connecting, in a third circuit configuration, i) the stator windings of the first group of stator windings between the first pair of subnetwork terminal poles, and ii) the stator windings of the second group of stator windings between the second pair of subnetwork terminal poles.

20. The method as recited in claim 19, further comprising:
connecting, in a fourth circuit configuration, the in-phase stator windings of the first and the second group of stator windings, as a DC voltage converter for DC voltage conversion, between the first and the second pair of subnetwork terminal poles.

21. The method as recited in claim 20, wherein, in the fourth circuit configuration, the in-phase stator windings of the first and the second group of stator windings are connected one of: as a transformer, as a step-up converter, or as a step-down converter for DC voltage conversion between the first and the second pair of subnetwork terminal poles.

22. The method as recited in claim 20, wherein the electric machine is operated in the fourth circuit configuration when a drive of the electric machine is operated in a start-stop operating mode.

23. The method as recited in claim 19, wherein the electric machine is operated in the first circuit configuration when a drive of the electric machine is operated in an idle state.

24. The method as recited in claim 19, wherein the electric machine is operated in the second circuit configuration when the electric machine is operated in a recuperation mode.

25. The method as recited in claim 19, wherein the electric machine is operated in the third circuit configuration when a drive of the electric machine is operated in a work operating mode.

26. The method as recited in claim 19, wherein the electric machine is operated.

27. A control unit designed to operate an electric machine including a first group of stator windings and a second group of stator windings, the control unit design to:
causing connection of, in a first circuit configuration, in-phase stator windings of the first and the second group of stator windings, in series between a first pair of subnetwork terminal poles;
cause connection of, in a second circuit configuration, the in-phase stator of the first and the second group of stator windings, in parallel between a second pair of subnetwork terminal poles; and
cause connection of, in a third circuit configuration, i) the stator windings of the first group of stator windings between the first pair of subnetwork terminal poles, and ii) the stator windings of the second group of stator windings between the second pair of subnetwork terminal poles.

28. A motor vehicle electrical system having two subnetworks, the system including an electric machine for a power supply of the motor vehicle electrical system, the electric machine comprising:
a first group of stator windings, a second group of stator windings, a first pair of subnetwork terminal poles and a second pair of subnetwork terminal poles, wherein the first group of stator windings is associated with a first rectifier circuit and the second group of stator windings is associated with a second rectifier circuit; and
a connection circuit situated between in-phase stator windings of the first and the second group of stator windings;
wherein the connection circuit and the first and second rectifier circuits are switchable into a first circuit configuration, in which the in-phase stator windings of the first and the second group of stator windings are connected in series between the first pair of subnetwork terminal poles via the connection circuit;
wherein the connection circuit and the first and second rectifier circuits are switchable into a second circuit configuration, in which the in-phase stator windings of the first and the second group of stator windings are connected in parallel between the second pair of subnetwork terminal poles; and
wherein the connection circuit and the first and second rectifier circuits are switchable into a third circuit configuration, in which the stator windings of the first group of stator windings are connected between the first pair of subnetwork terminal poles and in which the stator windings of the second group of stator windings are connected between the second pair of subnetwork terminal poles.

29. A non-transitory machine-readable storage medium on which is stored a computer program for operating an electric machine including a first group of stator windings and a second group of stator windings, the computer program, which executed by a controller, causing the controller to perform comprising:
connecting, in a first circuit configuration, in-phase stator windings of the first and the second group of stator windings, in series between a first pair of subnetwork terminal poles;
connecting, in a second circuit configuration, the in-phase stator of the first and the second group of stator windings, in parallel between a second pair of subnetwork terminal poles; and
connecting, in a third circuit configuration, i) the stator windings of the first group of stator windings between the first pair of subnetwork terminal poles, and ii) the stator windings of the second group of stator windings between the second pair of subnetwork terminal poles.
